(19) United States
(12) Patent Application Publication
(10) Pub. No.: US 2026/0126640 A1
(43) Pub. Date: May 7, 2026

(54) LONG-RANGE OPTICAL DEVICE

(71) Applicant: STEINER-OPTIK GmbH, Bayreuth (DE)

(72) Inventors: Oliver JÄSCHKE, Bayreuth (DE); Gerd LOTTES, Bayreuth (DE)

(73) Assignee: STEINER-OPTIK GmbH, Bayreuth (DE)

(21) Appl. No.: 19/118,309

(22) PCT Filed: Nov. 6, 2023
(86) PCT No.: PCT/EP2023/080785

§ 371 Date: Apr. 3, 2025

(30) Foreign Application Priority Data
Nov. 9, 2022 (DE) 10 2022 129 647.4

(51) Int. Cl. G02B 23/18

(52) U.S. Cl. CPC G02B 23/18

(57) ABSTRACT

Long-range optical device (1), in particular a pair of binoculars, comprising at least one housing body (4) for accommodating at least one optical element and at least one fastening device (5) for fastening a third object, in particular a belt, to the at least one housing body (4), the at least one fastening device (5) comprising at least one fastening element (8) movably mounted with one translational degree of freedom of movement between a fastening position, in which a portion of the third object accommodated in a reception device (7) is fastened to the at least one housing body (4), and a non-fastening position, in which the portion of the third object accommodated in the reception device (7) is not fastened to the at least one housing body (4).

The invention relates to a long-range optical device, in particular a pair of binoculars, comprising a housing body and at least one fastening device for fastening a third object, in particular a belt, to the housing body.

Corresponding long-range optical devices are known in principle from the prior art and comprise a housing body that typically receives one or more optical elements, such as optical lenses, and a fastening device for fastening a third object, in particular a belt, to the housing body.

Although the fastening devices of known long-range optical devices comprise a reliable, if necessary detachable, fastening of a third object, such as a belt or carrying strap, to the housing body, they are hitherto configured in a complicated manner with respect to construction and handling.

This can result in a user having difficulty in transferring a fastening element belonging to a corresponding fastening device from a fastening position, in which a third object is fastened to the housing body, into a non-fastening position, in which the third object is not fastened to the housing body, for example because the actuations of the fastening element necessary for this and to be performed on the user side-which generally require pivoting of the fastening element about a pivot axis-are effective and/or intuitive only to a limited extent with regard to the forces that are generated thereby and act on the fastening element.

The object of the invention is that of specifying a long-range optical device that is improved in comparison.

The object is achieved by a long-range optical device according to independent claim 1. The claims dependent thereon relate to possible embodiments of the long-range optical device.

A first aspect of the invention relates to a long-range optical device. The long-range optical device generally constitutes an optical device which is configured for observing objects located at a distance with respect to a location of a user-these are to be understood as both animate and inanimate objects. When used as intended, the long-range optical device is intended to be held by a user to at least one eye by at least one hand, such that a user can look through at least one optical channel of the long-range optical device that accommodates one or more optical elements. A corresponding optical channel typically extends between an eyepiece and an objective; the one or more optical elements, such as optical lenses, prisms, etc., are therefore typically arranged between an eyepiece and an objective. Of course, the eyepiece and the objective can also each be formed by or comprise at least one optical element, in particular in the form of a lens.

The long-range optical device can, typically on account of the optical properties of the one or more optical elements accommodated in the optical channel, allow for an, optionally variable, manyfold optical enlargement. This is not necessarily the case, however-the long-range optical device can therefore optionally also allow only for a single enlargement.

However, if the long-range optical device allows for an, optionally variable, manyfold optical enlargement, it can be configured as binoculars or a telescope. In particular, embodiments as what is known as a monocular or binoculars, for example in a roof edge or Porro configuration, are also possible. In an embodiment as binoculars, the long-range optical device comprises two housing bodies; each housing body comprises an eyepiece and an objective, as well as one or more optical elements arranged between the eyepiece and the objective. Each housing body thus forms an optical channel; the central axes of the optical channels of respective housing bodies typically can be or are arranged in parallel with one another. Similar applies for embodiments as a monocular, in which the long-range optical device comprises just one (single) housing body and one single optical channel.

In addition to the mentioned configuration as binoculars or a telescope, the long-range optical device can be configured e.g. as an infrared vision device, night vision device, etc.

Thus, in a basic configuration, in all cases the long-range optical device comprises at least one housing body. The at least one housing body can be configured in one piece or in multiple parts; at least one optical element is accommodated in the at least one housing body; the at least one housing body thus forms an optical channel of the long-range optical device.

The long-range optical device further comprises at least one fastening device for fastening a third object to the at least one housing body. The third object can be a belt or a carrying strap. A corresponding belt or carrying strap can make it possible to carry the long-range optical device around the neck in a manner known per se. As emerges in the following, the at least one fastening device can be configured, depending on the configuration of the third object, to fasten the third object to the at least one housing body directly or indirectly, i.e. with interposition of at least one intermediate component, e.g. an attachment piece.

The at least one fastening device comprises at least one fastening element that is mounted so as to be movable in one translational degree of freedom of movement between a fastening position, in which a portion of the third object accommodated in a reception device is fastened to the at least one housing body, and a non-fastening position, in which the portion of the third object accommodated in the reception device is not fastened to the at least one housing body. The at least one fastening device thus allows for (damage-free or destruction-free) fastening of a third object to the at least one housing body by transferring the at least one fastening element from the fastening position into the non-fastening position. If the at least one long-range optical device comprises a plurality of housing bodies, each housing body can comprise at least one fastening element that is mounted so as to be movable in one translational degree of freedom of movement between a fastening position, in which a portion of the third object accommodated in a reception device is fastened to the at least one housing body, and a non-fastening position, in which the portion of the third object accommodated in the reception device is not fastened to the at least one housing body.

A respective reception device can be defined by one or more walls of a reception unit. The one or more walls can define a receiving shaft for accommodating a portion of the third object or a corresponding attachment piece that can be or is coupled thereto. The receiving shaft has a depth that extends in a receiving shaft axis. Viewed in cross-section, the receiving shaft can have a geometry that corresponds to the cross-sectional geometry of the respective portion of the third object or attachment piece.

A respective reception unit can be formed integrally with the at least one housing body or can be formed as a module separate from the at least one housing body, which can be or is fastened to the at least one housing body in a stable manner by means of one or more form-fitting and/or force-fitting and or integral fastening means. Corresponding fastening means can be e.g. a clamping, latching, screw or adhesive means.

What is essential is for the at least one fastening element to be mounted so as to be movable in one translational degree of freedom of movement. The at least one fastening element should thus be moved in a translational degree of freedom of movement in order to transfer it into the fastening position and into the non-fastening position. Corresponding movements of the at least one fastening element thus occur in or along a translation axis defined by at least two points; in this case, a first point typically correlates with the fastening position and a second point with the non-fastening position of the at least one fastening element. The at least two points in particular define a straight line; the translation axis is therefore typically a linear axis. The translation axis is typically arranged or oriented so as to be at an angle, i.e. in particular at a right angle, relative to the receiving shaft axis. The movement direction for moving the at least one fastening element into the fastening position and/or into the non-fastening position can thus be at an angle, in particular at a right angle, to the movement direction for inserting the third object, in particular at least one mating effective portion, which is described in more detail in the following and which can be or is coupled to the third object, into the reception device.

The fact of transferring the at least one fastening element into the fastening position and/or into the non-fastening position by a simple translational movement in or along the translation axis provides a solution to configure actuations of the at least one fastening element, to be performed on the user side, for transferring the at least one fastening element into the fastening position and/or into the non-fastening position to be very effective and/or very intuitive, in particular in contrast with known swivel mountings, in view of the forces generated thereby and acting on the fastening element.

Thus, overall, an improved long-range optical device is provided.

The at least one fastening device can be arranged or formed on or in the at least one housing body. In this way, a reliable structural placement of the at least one fastening device on a typically very stable component of the long-range optical device, specifically the at least one main body, can be achieved. Therefore, possible forces acting on the at least one fastening device when the long-range optical device is used, i.e. in particular tensile forces, can be absorbed by a very stable component of the long-range optical device.

In particular, the at least one fastening device can be fastened, in particular detachably, on or in the at least one housing body as a separate module. This can have advantages in particular with respect to manufacturing, as the at least one fastening device can be manufactured as a separate module. Furthermore, the at least one fastening device configured as a separate module can be exchanged (more) easily, for example in the event of damage. A detachable fastening of the at least one fastening device to the at least one housing body can be achieved e.g. via one or more form-fitting and/or force-fitting and/or integral fastening means; corresponding fastening means can be or comprise e.g. a clamping, latching or screw means.

The at least one fastening element can comprise at least one effective portion which is configured to interact, in the fastening position, with at least one mating effective portion, in particular of an attachment piece, which can be or is coupled to the third object, forming a form-fitting fastening of the third object to the at least one housing body. In the fastening position, a form-fitting connection can thus be established by the interaction of the at least one effective portion of the at least one fastening element with at least one mating effective portion coupled to the third object, which form-fitting connection typically allows for fastening of the third object to the at least one housing body that is typically very stable with respect to absorbable forces, i.e. in particular tensile forces. As emerges in the following, the at least one mating effective portion can be coupled to the third object directly or indirectly, i.e. with interposition of at least one component or one component group.

The at least one effective portion of the at least one fastening element can be configured as a form-fitting portion, and the at least one mating effective portion that can be or is coupled to the third object can be configured as a corresponding mating form-fitting portion. Corresponding form-fitting and mating form-fitting portions can be implemented structurally for example by mirror-inverted latching and/or snap elements. Corresponding form-fitting and mating form-fitting portions can thus be implemented for example by, optionally undercut, projections, and receiving regions corresponding thereto. Optionally, a guided movement of the fastening element into the fastening and/or into the non-fastening position can also be achieved or at least assisted by corresponding form-fitting and mating form-fitting portions.

In a specific embodiment, the at least one mating form-fitting portion can be formed by a recess through which the at least one form-fitting portion passes in the fastening position, in particular in a direction transversely to a longitudinal extension of the at least one mating form-fitting portion. In particular, two leg-like or leg-shaped mating form-fitting portions can be provided, which define an intermediate space that forms a corresponding recess. The two leg-like or leg-shaped mating form-fitting portions can be configured so as to each have at least one projection, oriented towards the respective other mating effective portion, in the region of mutually facing surfaces; respective leg-like or leg-shaped mating form-fitting portions can thus each have an L-like or L-shaped basic shape, wherein the short portions of the respective Ls face one another. The at least one effective portion corresponding thereto can accordingly have a T-like or T-shaped basic shape, such that in the fastening position engagement of the short portions of the respective L behind or around the short portions of the T results. It follows from this, in general, that the at least one effective portion can be configured having one or more undercuts, behind which the at least one mating effective portion can engage in the fastening position.

It has been mentioned that the at least one mating effective portion can be coupled to the third object directly or indirectly, i.e. with interposition of at least one component or one component group. An embodiment of indirect coupling can for example be achieved in that the at least one mating effective portion is arranged or formed on an attachment piece which is arranged on or formed with the third object. A corresponding attachment piece can be formed from a different material or a different material structure than the third object which, as mentioned, can in particular be a belt; a corresponding attachment piece can therefore be formed from a sufficiently strong material or a sufficiently strong material structure to withstand possible forces, i.e. in particular tensile forces. Specifically, a corresponding attachment piece can thus be formed of or comprise e.g. a plastics material, in particular a hard plastics material, or a metal. A corresponding attachment piece can thus be e.g. an injection-molded part, a milled part, a bent or punched part, a 3D-printed part, etc.

The at least one effective portion can be configured having an, in particular ramp-like or ramp-shaped, insertion portion which, upon insertion of the mating effective portion into the reception device, can be acted on by force in such a way that the at least one fastening element can be or is moved into the non-fastening position. In this way, a transfer of the at least one fastening element into the non-fastening position and/or into the fastening position, which transfer can possibly be experienced haptically by a user, can be achieved, because the forces required for transferring the at least one fastening element into the fastening position and/or into the fastening position can be more easily and better “experienceable”.

A corresponding insertion portion can be configured e.g. as an, in particular ramp-like or ramp-shaped, sloping surface relative to a base portion of the fastening element. A corresponding insertion portion, i.e. in particular a corresponding sloping surface, can be arranged or formed on an upper side of the at least one fastening element facing away from an insertion opening into the reception device.

The long-range optical device can comprise a restoring device which is associated with the at least one fastening device and is configured for exerting a restoring force that moves the at least one fastening element into the fastening position. The restoring force that can be exerted by the restoring device on the at least one fastening element and moves said element into the fastening position typically acts in the translation axis. The force vector of the restoring force typically opposes a movement vector of the at least one fastening element, in order to transfer said element into the non-fastening position. The restoring device makes it possible to prevent undesired loss of a third object fastened to the at least one housing body by the at least one fastening device, because the at least one fastening element is always moved into or in the direction of the fastening position by means of the restoring device. Therefore, the restoring device also makes it possible for it not to be necessary for a user to actively transfer the at least one fastening element into the fastening position or to secure it therein, because the at least one fastening element is always moved into or in the direction of the fastening position by means of the restoring device. The basic position of the at least one fastening element can therefore be the fastening position.

The restoring device can comprise at least one restoring element which is configured as or comprises a return spring, i.e. in particular a pressure spring, and which is configured for exerting the restoring force that moves the at least one fastening element into the fastening position. The return spring-and analogous applies for any other restoring element-can be arranged or oriented having its spring axis in the translation axis; in this way, it is possible that the force vector of the restoring force opposes a movement vector of the at least one fastening element, in order to transfer said element into the non-fastening position.

The long-range optical device can comprise an adapter device which defines the receiving space at least in portions and which can be or is detachably fastened to the at least one housing body. A corresponding adapter device makes it possible to adjust the at least one fastening device to or provided it on differently dimensioned mating effective portions, because differently dimensioned adapter devices make it possible for differently dimensioned receiving spaces for differently dimensioned mating effective portions to be provided.

The long-range optical device can comprise an actuation device which comprises an actuation element which is coupled, i.e. in particular movement-coupled, to the fastening element and which can be actuated by a user for transferring the at least one fastening element at least into the non-fastening position. A corresponding user-side actuation of the actuation element can also serve for holding the fastening element temporarily in the non-fastening position. An expedient introduction of forces for transferring the fastening element into the non-fastening position can be achieved by a corresponding actuation device, which improves the handling of the at least one fastening device.

The actuation element can be arranged in a manner having an exposed actuation portion terminating (substantially) flush with an exposed outer surface of the at least one housing body, in the fastening position. The actuation element can thus be arranged or configured in the at least one housing body in a highly integrated manner; in particular, the actuation element does not change (or barely changes) the outside appearance of the at least one housing body.

A second aspect of the invention relates to a fastening device for a long-range optical device according to the first aspect of the invention. The fastening device comprises a fastening element that is mounted so as to be movable in one translational degree of freedom of movement between a fastening position, in which a portion of the or a third object accommodated in a reception device is fastened to the at least one housing body of the long-range optical device, and a non-fastening position, in which the portion of the third object accommodated in the reception device is not fastened to the at least one housing body of the long-range optical device.

A third aspect of the invention relates to a long-range optical assembly which comprises a long-range optical device according to the first aspect and a third object that can be or is fastened to the at least one housing body of the long-range optical device by means of the fastening device.

All the statements made in connection with the long-range optical device according to the first aspect of the invention apply analogously for the fastening device according to the second aspect of the invention and for the long-range optical assembly according to the third aspect of the invention.

The invention is explained again in the following on the basis of embodiments and with reference to the figures, in which:

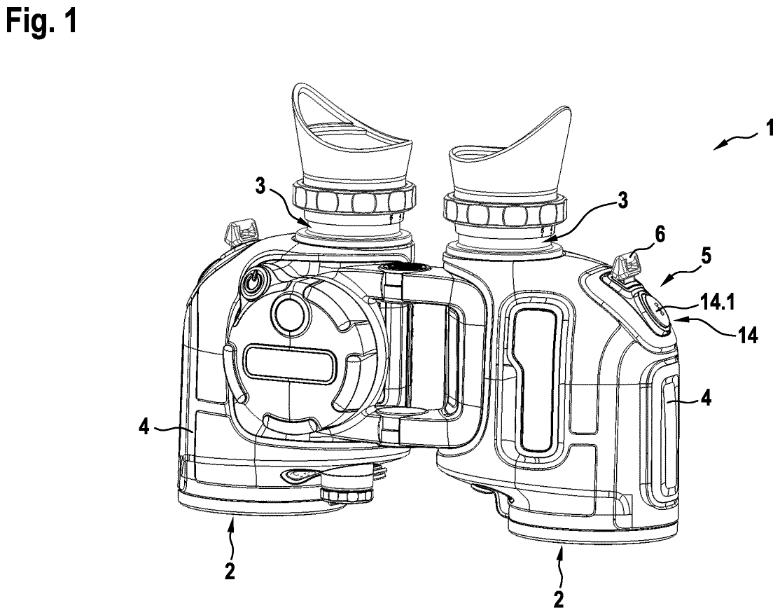

FIG. 1 is a schematic view of a long-range optical device according to one embodiment;

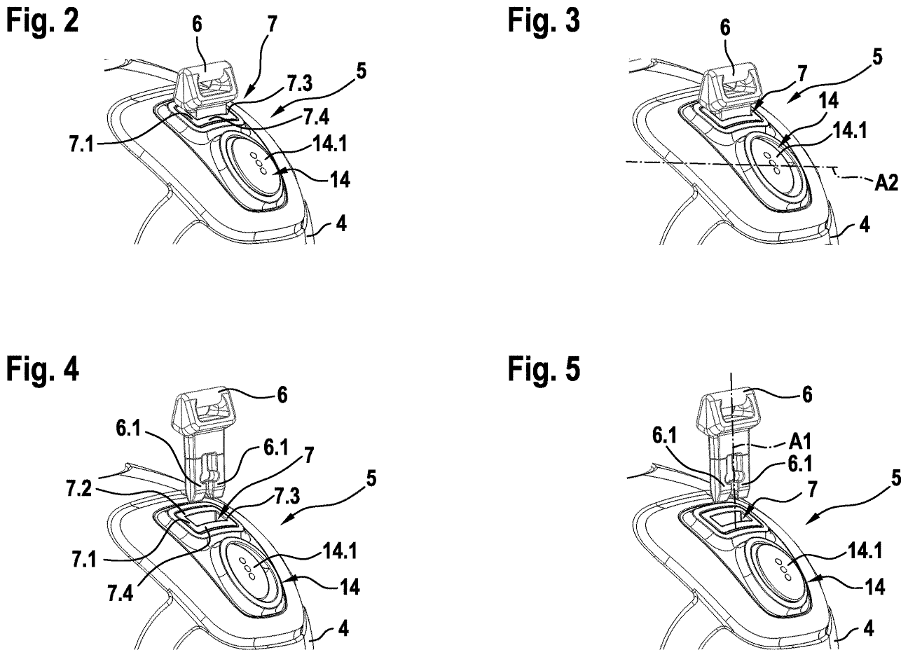

FIG. 2-5 are enlarged views of the long-range optical device having fastening elements moved into different positions, according to one embodiment;

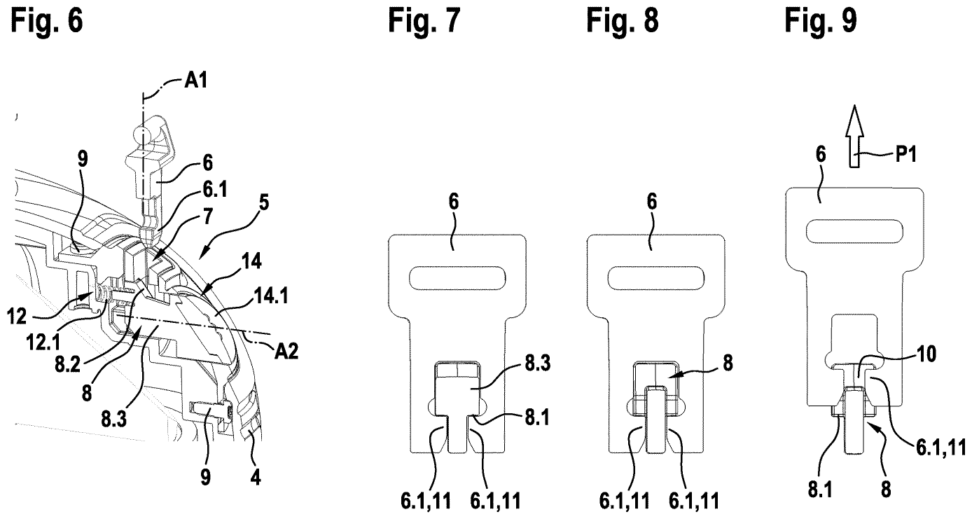

FIG. 6 is a sectional view of the long-range optical device according to one embodiment;

FIG. 7-9 are each schematic views of effective portions and mating effective portions according to one embodiment; and

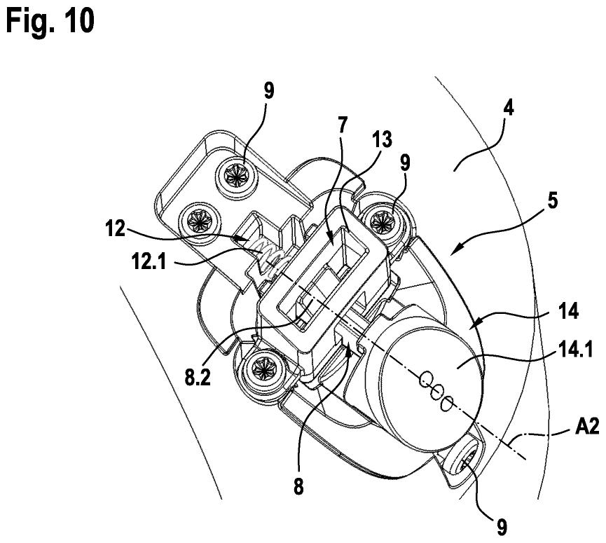

FIG. 10 is an enlarged view of an adapter device of the long-range optical device according to one embodiment.

FIG. 1 is a schematic perspective view of a long-range optical device 1 according to one embodiment.

The long-range optical device 1 generally constitutes an optical device which is configured for observing objects located at a distance with respect to a location of a user—these are to be understood as both animate and inanimate objects. When used as intended, the long-range optical device 1 is intended to be held by a user to at least one eye by at least one hand, such that a user can look through an optical channel of the long-range optical device 1 that accommodates one or more optical elements. A corresponding optical channel typically extends between a respective eyepiece 3 and a respective objective 2; the one or more optical elements, such as optical lenses, prisms, etc., are therefore typically arranged between the respective eyepiece 3 and the respective objective 2. Of course, the respective eyepiece 3 and the respective objective 2 can also be formed by or comprise at least one optical element, in particular in the form of a lens.

The long-range optical device 1 can, typically on account of the optical properties of the one or more optical elements accommodated in the respective optical channel, allow for an, optionally variable, manyfold optical enlargement. This is not necessarily the case however—the long-range optical device 1 can therefore optionally also allow only for a single enlargement.

In the embodiment shown in FIG. 1, the long-range optical device 1 is configured by way of example as a pair of binoculars which allows for an, optionally variable, manyfold optical enlargement. The binoculars comprise two housing bodies 4; each housing body 4 comprises an eyepiece 3 and an objective 2, as well as one or more optical elements arranged between the eyepiece 3 and the objective 2. Each housing body 4 thus forms an optical channel; the central axes of the optical channels of respective housing bodies 4 typically can be or are arranged in parallel with one another.

Thus, in a basic configuration, in all cases the long-range optical device 1 comprises at least one housing body 4. The housing body 4 can be configured in one piece or in multiple parts; as mentioned, at least one optical element is accommodated in the at least one housing body 4; each housing body 4 thus forms an optical channel of the long-range optical device 1.

It can be seen from FIG. 1 that a fastening device 5 for fastening a third object (not shown) is formed on each main body 4, on the long-range optical device 1. The third object can be a belt or a carrying strap which makes it possible to carry the long-range optical device 1 around the neck in a manner known per se. As emerges in the following, each fastening device 5 can be configured, depending on the configuration of the third object, to fasten the third object to the respective housing body 4 directly or indirectly, i.e. with interposition of at least one intermediate component, e.g. an attachment piece 6.

The following explanations in connection with a fastening device 5 apply analogously for each fastening device 5 of the long-range optical device 1.

The fastening device 5 comprises a fastening element 8 that is mounted so as to be movable in one degree of freedom of movement between a fastening position, e.g. shown in FIG. 2, in which a portion of the third object, specifically the mentioned attachment piece 6, accommodated in a reception device 7 is fastened to the housing body 4, and a non-fastening position, e.g. shown in FIG. 3, 4 or 9, in which the portion of the third object accommodated in the reception device 7 is not fastened to the at least one housing body 4. The fastening device 5 thus allows for (damage-free or destruction-free) fastening of a third object to the housing body 4 by transferring the fastening element 8 from the fastening position into the non-fastening position. If the long-range optical device 1 comprises a plurality of housing bodies 4, each housing body 1 can comprise a fastening element 8 that is mounted so as to be movable in one translational degree of freedom of movement between a fastening position, in which a portion of the third object accommodated in a reception device 7 is fastened to the housing body 4, and a non-fastening position, in which the portion of the third object accommodated in the reception device 7 is not fastened to the housing body 4.

It can be seen with reference to FIGS. 2, 4, 5, 6 and 10 that a respective reception device 7 can be defined by one or more walls 7.1-7.4 of a reception unit (not denoted). The one or more walls 7.1-7.4 can define a receiving shaft for accommodating a portion of the third object or a corresponding attachment piece 6 that can be or is coupled thereto. The receiving shaft has a depth that extends in a receiving shaft axis A1 (cf. in particular FIG. 6) and, as shown by way of example in the figures, viewed in cross-section can have a geometry that corresponds to the cross-sectional geometry of the respective portion of the third object or attachment piece 6.

A respective reception unit can be formed integrally with the housing body 4 or, as shown by way of example in the figures, can be formed as a module separate from the housing body 4, which can be or is fastened to the housing body 4 in a stable manner by means of one or more form-fitting and/or force-fitting and or integral fastening means 9. Corresponding fastening means 9 can be e.g. a clamping, latching, screw or adhesive means. In the embodiment according to FIG. 1, purely by way of example screw means are shown.

What is essential is for the fastening element 8 to be mounted so as to be movable in one translational degree of freedom of movement. The fastening element 8 should thus be moved in a translational degree of freedom of movement in order to transfer it into the fastening position and into the non-fastening position. Corresponding movements of the fastening element 8 thus occur in or along a translation axis A2 defined by at least two points; in this case, a first point typically correlates with the fastening position and a second point with the non-fastening position of the fastening element 8. The at least two points in particular define a straight line; the translation axis A2 is therefore typically a linear axis. In the embodiments, the translation axis A2 is typically arranged or oriented so as to be at an angle, i.e. in particular at a right angle, relative to the receiving shaft axis A1. The movement direction for moving the fastening element 8 into the fastening position and/or into the non-fastening position can thus be at an angle, in particular at a right angle, to the movement direction for inserting the third object, in particular a mating effective portion, which is described in more detail in the following and which can be or is coupled to the attachment piece 6, into the reception device 7.

The fact of transferring the fastening element 8 into the fastening position and/or into the non-fastening position by a simple translational movement in or along the translation axis A2 provides a solution to configure actuations of the fastening element 8, to be performed on the user side, for transferring the fastening element 8 into the fastening position and/or into the non-fastening position to be very effective and very intuitive, in particular in contrast with known swivel mountings, in view of the forces generated thereby and acting on the fastening element 8.

It can be seen from the figures that the fastening device 5 can be arranged or formed on or in the respective housing body 4. In this way, a reliable structural placement of the fastening device 5 on a typically very stable component of the long-range optical device 1, specifically a respective main body 4, can be achieved. Therefore, possible forces acting on the respective fastening device 5 when the long-range optical device 1 is used, i.e. in particular tensile forces, can be absorbed by a very stable component of the long-range optical device 1.

It can be seen in particular from the figures that the fastening device 5 can also be fastened, in particular detachably, on or in the housing body 4 as a separate module. This can have advantages in particular with respect to manufacturing, as the fastening device 5 can be manufactured as a separate module. Furthermore, the fastening device 5 configured as a separate module can be exchanged (more) easily, for example in the event of damage. A detachable fastening of the fastening device 5 to the housing body 4 can be achieved e.g. via one or more form-fitting and/or force-fitting and/or integral fastening means; corresponding fastening means can be or comprise e.g. a clamping, latching or screw means. In the embodiment according to FIG. 1, purely by way of example screw means are shown.

It can be seen from FIG. 7-9, which are axial views with respect to the translation axis A2, that the fastening element 8 can comprise at least one effective portion 8.1 which is configured to interact, in the fastening position shown in FIG. 7, with a mating effective portion 6.1 of an attachment piece 6 that can be or is coupled to the third object, forming a form-fitting fastening of the third object to the housing body 4. In the fastening position, a form-fitting connection can thus be established by the interaction of the at least one effective portion 8.1 with the at least one mating effective portion 6.1, which form-fitting connection typically allows for fastening of the third object to the housing body 4 that is typically very stable with respect to absorbable forces, i.e. in particular tensile forces (cf. the arrow P1 in FIG. 9).

It can furthermore be seen from FIG. 7-9 that the at least one effective portion 8.1 can be configured as a form-fitting portion, and the at least one mating effective portion 6.1 can be configured as a corresponding mating form-fitting portion. Corresponding form-fitting and mating form-fitting portions can be implemented structurally for example by mirror-inverted latching and/or snap elements. Corresponding form-fitting and mating form-fitting portions can thus be implemented for example by, optionally undercut, projections, and receiving regions corresponding thereto. Optionally, a guided movement of the fastening element 8 into the fastening and/or into the non-fastening position can also be achieved or at least assisted by corresponding form-fitting and mating form-fitting portions.

In the embodiment shown in the figures, the at least one mating form-fitting portion is formed by a recess through which the at least one form-fitting portion passes in the fastening position shown in FIG. 7, in particular in a direction transversely to a longitudinal extension of the at least one mating form-fitting portion. By way of example, two leg-like or leg-shaped mating form-fitting portions are provided, which define an intermediate space 10 that forms a corresponding recess. The two leg-like or leg-shaped mating form-fitting portions can be configured so as to each have at least one projection 11, oriented towards the respective other mating effective portion, in the region of mutually facing surfaces; respective leg-like or leg-shaped mating form-fitting portions can thus each have an L-like or L-shaped basic shape, wherein the short portions of the respective Ls face one another. The at least one effective portion 8.1 corresponding thereto can accordingly have a T-like or T-shaped basic shape, such that in the fastening position engagement of the short portion of the respective L behind or around the short portions of the T results. It follows from this, in general, that the at least one effective portion 8.1 can be configured having one or more undercuts, behind which the at least one mating effective portion 6.1 can engage in the fastening position. FIG. 8 shows the fastening element 8 in the non-fastening position; the fastening element 8 is located behind the attachment piece 6 in the sheet plane, such that the form-fitting connection provided in FIG. 7 is released and the attachment piece, as shown in FIG. 9, can be moved according to the direction indicated by the arrow P1, in order to ultimately separate it from the main body 4.

It has been mentioned that the at least one mating effective portion 6.1 can be coupled to the third object directly or indirectly, i.e. with interposition of at least one component or one component group. An embodiment of indirect coupling can, as shown in the figures, for example be achieved in that the at least one mating effective portion 6.1 is arranged or formed on an attachment piece 6 which is arranged on or formed with the third object. The attachment piece 6 can be formed from a different material or a different material structure than the third object which, as mentioned, can in particular be a belt or a carrying strap; the attachment piece 6 can therefore be formed from a sufficiently strong material or a sufficiently strong material structure to withstand possible forces, i.e. in particular tensile forces. Specifically, the attachment piece 6 can thus be formed of or comprise e.g. a plastics material, in particular a hard plastics material, or a metal.

It can be seen from FIG. 6 that the at least one effective portion 8.1 can be configured having an, in particular ramp-like or ramp-shaped, insertion portion 8.2 which, upon insertion of the at least one mating effective portion 6.1 into the reception device, can be acted on by force in such a way that the at least one fastening element 8 can be or is moved into the non-fastening position. In this way, a transfer of the fastening element 8 into the non-fastening position, which transfer can possibly be experienced haptically by a user, can be achieved, because the forces required for transferring the fastening element 8 into the non-fastening position can be more easily and better “experienceable”.

In the embodiment according to FIG. 6, the insertion portion 8.2 is configured by way of example as an, in particular ramp-like or ramp-shaped, sloping surface relative to a base portion 8.3 of the fastening element 8. In the embodiment, the insertion portion 8.2, i.e. in particular a corresponding sloping surface, is arranged or formed on an upper side of the fastening element 8 facing away from an insertion opening into the reception device.

It can furthermore be seen from FIG. 6 that the long-range optical device 1 can comprise a restoring device 12 which is associated with the fastening device 5 and is configured for exerting a restoring force that moves the fastening element 8 into the fastening position. The restoring force that can be exerted by the restoring device 12 on the fastening element 8 and moves said element into the fastening position typically acts in the translation axis A2. The force vector of the restoring force thus typically opposes a movement vector of the fastening element 8, in order to transfer said element into the non-fastening position. The restoring device 12 makes it possible to prevent undesired loss of a third object fastened to the housing body 4 by the fastening device 7, because the fastening element 8 is always moved into or in the direction of the fastening position by means of the restoring device 12. Therefore, the restoring device 12 also makes it possible for it not to be necessary for a user to actively transfer the fastening element 8 into the fastening position or to secure it therein, because the fastening element 8 is always moved into or in the direction of the fastening position by means of the restoring device 12. The basic position of the fastening element 8 can therefore be the fastening position.

In the embodiment, the restoring device 12 comprises a restoring element 12.1 which is configured as or comprises a return spring, i.e. in particular a pressure spring, and which is configured for exerting the restoring force that moves the fastening element 8 into the fastening position. The return spring-and analogous applies for any other restoring element-can be arranged or oriented having its spring axis in the translation axis A2; in this way, it is possible that the force vector of the restoring force opposes a movement vector of the fastening element 8, in order to transfer said element into the non-fastening position.

It can be seen from FIG. 10 that the long-range optical device 1 can comprise an adapter device 13 which defines the receiving space at least in portions and which can be or is detachably fastened to the housing body 4. A corresponding adapter device 13 makes it possible to adjust the fastening device 5 to or provided it on differently dimensioned mating effective portions 6.1, because differently dimensioned adapter devices 13 make it possible for differently dimensioned receiving spaces for differently dimensioned mating effective portions 6.1 to be provided.

In all the embodiments, the long-range optical device 1 comprises an actuation device 14 which comprises an actuation element 14.1 which is coupled, i.e. in particular movement-coupled, to the fastening element 8 and which can be actuated by a user for transferring the fastening element 8 at least into the non-fastening position. A corresponding user-side actuation of the actuation element 14.1 can be seen in particular in FIGS. 3 and 4. It follows from this that a corresponding user-side actuation of the actuation element 14.1 also serves for holding the fastening element 8 temporarily in the non-fastening position. An expedient introduction of forces for transferring the fastening element 8 into the non-fastening position can be achieved by a corresponding actuation device 14, which improves the handling of the fastening device 5.

The actuation element 14.1 can, as can be seen in particular from FIGS. 2 and 5, be arranged in a manner having an exposed actuation portion terminating (substantially) flush with an exposed outer surface of the housing body 4, in the fastening position. The actuation element 14.1 can thus be arranged or configured in the housing body 4 in a highly integrated manner; in particular, the actuation element does not change (or barely changes) the outside appearance of the housing body 4.

The principle for transferring the fastening element 8 from the fastening position shown in FIG. 2 into its non-fastening position, and furthermore the principle for releasing the fastening of an attachment piece 6 and a third object coupled thereto, are also illustrated with reference to FIG. 2-4:

Proceeding from the state shown in FIG. 2, the fastening element 8 is transferred counter to the force vector of the restoring element 12.1 and thus counter to the force of the restoring element 12.1 into the non-fastening position (cf. FIG. 3) by actuation of the actuation element 14.1 in the direction of the translation axis A 2. The attachment piece 6 can then, as in FIG. 6, be removed from the reception device 7, again when the actuation element 14.1 is actuated correspondingly. After removal of the attachment piece 6 from the reception device 7, the fastening element 8 and thus the actuation element 14.1 coupled thereto is transferred in the direction of the translation axis A2 the fastening element 8 in the direction of the force vector of the restoring element 12.1, into the fastening position (cf. FIG. 5).

1. A long-range optical device (1), comprising at least one housing body (4) for accommodating at least one optical element and at least one fastening device (5) for fastening a third object, to the at least one housing body (4), characterized in that the at least one fastening device (5) comprising at least one fastening element (8) mounted so as to be moveable in one translational degree of freedom of movement between a fastening position, in which a portion of the third object accommodated in a reception device (7) is fastened to the at least one housing body (4), and a non-fastening position, in which the portion of the third object accommodated in the reception device (7) is not fastened to the at least one housing body (4).

2. The long-range optical device according to claim 1, wherein the fastening device (5) is arranged on or in the at least one housing body (4).

3. The long-range optical device according to claim 1, further comprising a restoring device (12) which is associated with the fastening device (5) and is configured for exerting a restoring force that moves the at least one fastening element (8) into the fastening position.

4. The long-range optical device according to claim 3, wherein the restoring device (12) comprises at least one restoring element (12.1) which is configured as or comprises a return spring and which is configured for exerting the restoring force that moves the at least one fastening element (8) into the fastening position.

5. The long-range optical device according to claim 1, wherein the at least one fastening element (8) comprises at least one effective portion (8.1) which is configured to interact, in the fastening position, with a mating effective portion (6.1) coupled to the third object, forming a form-fitting fastening of the third object to the at least one housing body (4).

6. The long-range optical device according to claim 5, wherein the at least effective portion (8.1) is configured as a form-fitting portion, and the at least one mating effective portion (6.1) is configured as a corresponding mating form-fitting portion.

7. The long-range optical device according to claim 5, wherein the mating form-fitting portion is formed by a recess through which the form-fitting portion passes in the fastening position in a direction transversely to a longitudinal extension of the mating form-fitting portion.

8. The long-range optical device according to claim 5, wherein the at least one mating effective portion (6.1) is arranged or formed on an attachment piece (6) which is arranged on or formed with the third object.

9. The long-range optical device according to claim 5, wherein the at least one effective portion (8.1) is configured having an insertion portion (8.2) which, upon insertion of the at least one mating effective portion (6.1) into the reception device (7), can be acted on by force in such a way that the at least one fastening element (8) is moved into the non-fastening position.

10. The long-range optical device according to claim 9, wherein the insertion portion (8.2) is arranged or formed on an upper side of the at least one fastening element (8) facing away from an insertion opening into the reception device (7).

11. The long-range optical device according to claim 1, wherein the at least one fastening device (5) is fastened on or in the at least one housing body (4) as a separate module.

12. The long-range optical device according to claim 1, further comprising an adapter device (12) which defines the receiving space at least in portions and which is detachably fastened to the at least one housing body (4).

13. The long-range optical device according to claim 1, wherein the movement direction for moving the at least one fastening element (8) into the fastening position and/or into the non-fastening position is at an angle relative to the movement direction for inserting the or a mating effective portion (6.1) into the reception device (7).

14. The long-range optical device according to claim 1, further comprising an actuation device (14) which comprises an actuation element (14.1) which is coupled to the at least one fastening element (8) and which can be actuated by a user for transferring the at least one fastening element (8) at least into the non-fastening position.

15. The long-range optical device according to claim 14, wherein the at least one actuation element (14.1) is arranged in a manner having an exposed actuation portion terminating flush with an exposed outer surface of the at least one housing body (4), in the fastening position.

16. A fastening device (5) for a long-range optical device (1) comprising at least one housing body (4) for accommodating at least one optical element and at least one fastening device (5) for fastening a third object to the at least one housing body (4),
wherein the fastening device (5) comprises a fastening element that is mounted so as to be movable in one translational degree of freedom of movement between a fastening position, in which a portion of the third object accommodated in a reception device is fastened to the housing body, and a non-fastening position, in which the portion of the third object accommodated in the reception device is not fastened to the at least one housing body.

17. A long-range optical assembly comprising the long-range optical device (1) according to claim 1 and a third object that can be or is fastened to the at least one housing body (4) of the long-range optical device (1) by means of the at least one fastening device (5).

18. The long-range optical device according to claim 1, wherein the long-range optical device comprises a pair of binoculars.

19. The long-range optical device according to claim 18, wherein the third object comprises a belt.

20. The long-range optical device according to claim 11, wherein the least one fastening device (5) is detachably fastened on or in the at least one housing body (4) as a separate module.
